(19) United States
(12) Patent Application Publication
(10) Pub. No.: US 2026/0168938 A1
(43) Pub. Date: Jun. 18, 2026

(54) GLASS TUBE PROCESSING PARAMETER DETECTION SYSTEM, METHOD AND APPARATUS

(71) Applicants: CHINA BUILDING MATERIALS ACADEMY CO., LTD., Beijing (CN); China National Building Material Group Co., Ltd., Beijing (CN)

(72) Inventors: Ran Zhao, Beijing (CN); Rui Zhang, Beijing (CN); Danqi Zhao, Beijing (CN); Yan Duan, Beijing (CN); Hui Liu, Beijing (CN); Yajie Du, Beijing (CN); Bo Liu, Beijing (CN)

(73) Assignees: CHINA BUILDING MATERIALS ACADEMY CO., LTD., Beijing (CN); China National Building Material Group Co., Ltd., Beijing (CN)

(21) Appl. No.: 19/306,501

(22) Filed: Aug. 21, 2025

(30) Foreign Application Priority Data
Dec. 16, 2024 (CN) 202411851863X

(51) Int. Cl. G01N 21/89; G06T 7/00; G06T 7/62; G06T 7/73; H04N 23/56

(52) U.S. Cl. CPC G01N 21/8914; G06T 7/0004; G06T 7/62; G06T 7/73; H04N 23/56

(57) ABSTRACT

A glass tube processing parameter detection system includes a tube descending platform, a conveying apparatus, a plurality of clamping apparatuses, a tube descending basket, a terminal device, and a photographing apparatus. The conveying apparatus includes a conveyor belt and conveyor belt rotating shafts. The clamping apparatuses are disposed on the conveyor belt to fix the glass tube to be detected. The photographing apparatus is configured to photograph end face images corresponding to the glass tube to be detected, and send the end face images corresponding to the glass tube to be detected to the terminal device. The terminal device is configured to control start and stop of rotation of the conveyor belt rotating shafts, and determine the processing parameters corresponding to the glass tube to be detected according to the end face images corresponding to the glass tube to be detected.

### TECHNICAL FIELD

The present application relates to the technical field of glass tube processing, and particularly to a glass tube processing parameter detection system, method and apparatus.

### BACKGROUND

Optical fiber image transmission elements (such as fiber optical plates, fiber optical inverters, fiber optical tapers, etc.) are fiber optic material bundles composed of tens of thousands to hundreds of thousands of micron-level optical fibers. In which, the optical fibers constituting the optical fiber image transmission elements are fabricated by drawing a hollow glass tube over a core glass rod, on the other words, the optical fibers are composed of two kinds of glasses with different compositions (namely, core glass and clad glass) and glass rods made of core glass are inserted into glass tubes made of clad glass, and the two are heated and stretched together to make optical fibers, that is, the processing quality of the optical fibers depends on the processing quality of the glass tube. Only the glass tube with processing quality meeting requirements can produce optical fibers with processing quality meeting requirements. Therefore, to ensure the processing quality of optical fibers, it is necessary to detect the processing quality of the glass tube.

Currently, laser detection method is typically used to detect the processing parameters of the glass tube, and then judge the processing quality of the glass tube based on the processing parameters of the glass tube. In which, during the process of detecting the processing parameters of the glass tube using laser detection, two lasers are required to perform multiple point-scanning operations on the glass tube. However, completing these multiple point-scanning operations requires staff to manually rotate the glass tube multiple times or manually rotate the lasers multiple times. Therefore, using laser detection to detect the processing parameters of the glass tube consumes significant time costs and labor costs, resulting in low detection efficiency.

### SUMMARY OF THE INVENTION

Embodiments of the present application provide a glass tube processing parameter detection system, method and apparatus, primarily aiming to improve the detection efficiency of detecting the glass tube processing parameters.

To solve the above technical problem, embodiments of the present application provide the following technical solutions:
In a first aspect, the present application provides a glass tube processing parameter detection system. The system includes: a tube descending platform, a conveying apparatus, a plurality of clamping apparatuses, a tube descending basket, a terminal device, and a photographing apparatus;
An output terminal of the tube descending platform is connected to an input terminal of the conveying apparatus, the tube descending basket is disposed below an output terminal of the conveying apparatus, and an input terminal of the tube descending platform is configured to deliver the glass tube to be detected;
The conveying apparatus is electrically connected to the terminal device, the conveying apparatus includes a conveyor belt and conveyor belt rotating shafts, and a plurality of the clamping apparatuses are disposed on the conveyor belt, and the clamping apparatuses are configured to fix the glass tube to be detected;
The photographing apparatus is disposed on one side of the conveying apparatus, the photographing apparatus is electrically connected to the terminal device, the photographing apparatus is configured to photograph end face images corresponding to the glass tube to be detected, and send the end face images corresponding to the glass tube to be detected to the terminal device;
The terminal device is configured to control start and stop of rotation of the conveyor belt rotating shafts, and determine the processing parameters corresponding to the glass tube to be detected according to the end face images corresponding to the glass tube to be detected.

In a second aspect, the present application further provides a glass tube processing parameter detection method. The method is applied to the terminal device in the glass tube processing parameter detection system described above in the first aspect. The method including:
Delivering a glass tube to be detected to the input terminal of the tube descending platform after receiving a detection instruction, and controlling the conveyor belt rotating shafts to start rotating after a target rolling duration to drive the conveyor belt to convey;
Controlling the photographing apparatus to photograph an end face image corresponding to the glass tube to be detected;
Determining processing parameters corresponding to the glass tube to be detected according to the end face image corresponding to the glass tube to be detected.

In a third aspect, the present application further provides a glass tube processing parameter detection apparatus. The apparatus is applied to the terminal device in the glass tube processing parameter detection system described above in the first aspect. The apparatus including:
A delivery unit, configured to deliver a glass tube to be detected to the input terminal of the tube descending platform after receiving a detection instruction;
A first control unit, configured to control the conveyor belt rotating shafts to start rotating after a target rolling duration to drive the conveyor belt to convey;
A second control unit, configured to control the photographing apparatus to photograph an end face image corresponding to the glass tube to be detected;
A determination unit, configured to determine processing parameters corresponding to the glass tube to be detected according to the end face image corresponding to the glass tube to be detected.

In a fourth aspect, an embodiment of the present application provides a storage medium. The storage medium includes a stored program, in which, the program, when executed, controls a device in which the storage medium is located to perform the glass tube processing parameter detection method described in the first aspect.

In a fifth aspect, an embodiment of the present application provides a glass tube processing parameter detection apparatus. The apparatus includes a storage medium; and one or more processors, the storage medium is coupled to the processor, and the processor is configured to perform program instructions stored in the storage medium; the program instructions, when executed, perform the glass tube processing parameter detection method according to the first aspect.

By virtue of the above technical solutions, the technical solutions provided by the present application at least have the following advantages:

The present application provides a glass tube processing parameter detection system, method and apparatus. The glass tube processing parameter detection system provided by the present application includes: a tube descending platform, a conveying apparatus, a plurality of clamping apparatuses, a tube descending basket, a terminal device, and a photographing apparatus; an output terminal of the tube descending platform is connected to an input terminal of the conveying apparatus, the tube descending basket is disposed below an output terminal of the conveying apparatus, and an input terminal of the tube descending platform is configured to deliver the glass tube to be detected; the conveying apparatus is electrically connected to the terminal device, the conveying apparatus includes a conveyor belt and conveyor belt rotating shafts, and a plurality of the clamping apparatuses are disposed on the conveyor belt, the clamping apparatuses are configured to fix the glass tube to be detected, the conveyor belt rotating shafts are configured to drive the conveyor belt to convey, after delivering a glass tube to be detected to the input terminal of the tube descending platform, the glass tube to be detected rolls from the input terminal of the tube descending platform to the clamping apparatus, the conveyor belt drives the clamping apparatus and the glass tube to be detected to move from the input terminal of the conveying apparatus to the output terminal of the conveying apparatus, and the tube descending basket is used for receiving the glass tube to be detected falling from the output terminal of the conveying apparatus; the photographing apparatus is disposed on one side of the conveying apparatus, the photographing apparatus is electrically connected to the terminal device, the photographing apparatus is configured to photograph end face images corresponding to the glass tube to be detected, and send the end face images corresponding to the glass tube to be detected to the terminal device; the terminal device is configured to control start and stop of rotation of the conveyor belt rotating shafts, and determine the processing parameters corresponding to the glass tube to be detected according to the end face images corresponding to the glass tube to be detected. Since, in the present application, the detection staff only need to deliver the glass tube to be detected at the input terminal of the tube descending platform and pick up the detected glass tube in the tube descending basket, and other steps do not need to be participated by the detection staff, the glass tube processing parameter detection system can automatically complete the work of detecting the processing parameters of the glass tube to be detected. Therefore, this can effectively reduce the time costs and labor costs consumed in detecting the processing parameters of the glass tube to be detected, thereby effectively improving detection efficiency.

The above description is merely an overview of the technical solutions of the present application. To understand the technical means of the present application more clearly, it can be implemented according to the content of the specification. Furthermore, to make the above and other objectives, features, and advantages of the present application more comprehensible, specific implementations of the present application are described below.

### BRIEF DESCRIPTION OF THE DRAWINGS

By referring to the following detailed description of the exemplary implementation of the present application in conjunction with the accompanying drawings, the above and other objects, features, and advantages of the present application will become readily understandable. In the drawings, several implementations of the present application are shown in an exemplary and non-limiting manner, and like or corresponding reference numerals designate like or corresponding parts, wherein:

FIG. 1 shows a schematic structural diagram of a glass tube processing parameter detection system provided by an embodiment of the present application;

FIG. 2 shows a schematic structural diagram of another glass tube processing parameter detection system provided by an embodiment of the present application;

FIG. 3 shows a flow chart of a glass tube processing parameter detection method provided by an embodiment of the present application;

FIG. 4 shows a composition block diagram of a glass tube processing parameter detection apparatus provided by an embodiment of the present application;

FIG. 5 shows a composition block diagram of another glass tube processing parameter detection apparatus provided by an embodiment of the present application.

### DETAILED DESCRIPTION OF EMBODIMENTS

The exemplary implementations of the present application will be described in more details below with reference to the drawings. Although the exemplary implementations of the present application are shown in the accompanying drawings, it should be understood that the present application can be implemented in various forms and should not be limited by the implementations described herein. On the contrary, these implementations are provided to enable a more thorough understanding of the present application and to fully convey the scope of the present application to those skilled in the art.

Furthermore, the terms “first”, “second”, and similar terms configured in the present application do not denote any order, quantity, or importance, but are merely used to distinguish different parts.

It should be noted that unless otherwise specified, technical terms or scientific terms used in the present application shall have the ordinary meanings understood by those skilled in the art to which the present application pertains.

At present, laser detection is typically used to detect the processing parameters of the glass tube, and then judge the processing quality of the glass tube based on the processing parameters of the glass tube. In which, during the process of detecting the processing parameters of the glass tube using laser detection, two lasers are required to perform multiple point-scanning operations on the glass tube. However, completing these multiple point-scanning operations requires staff to manually rotate the glass tube multiple times or manually rotate the lasers multiple times. Therefore, using laser detection to detect the processing parameters of the glass tube consumes significant time costs and labor costs, resulting in low detection efficiency.

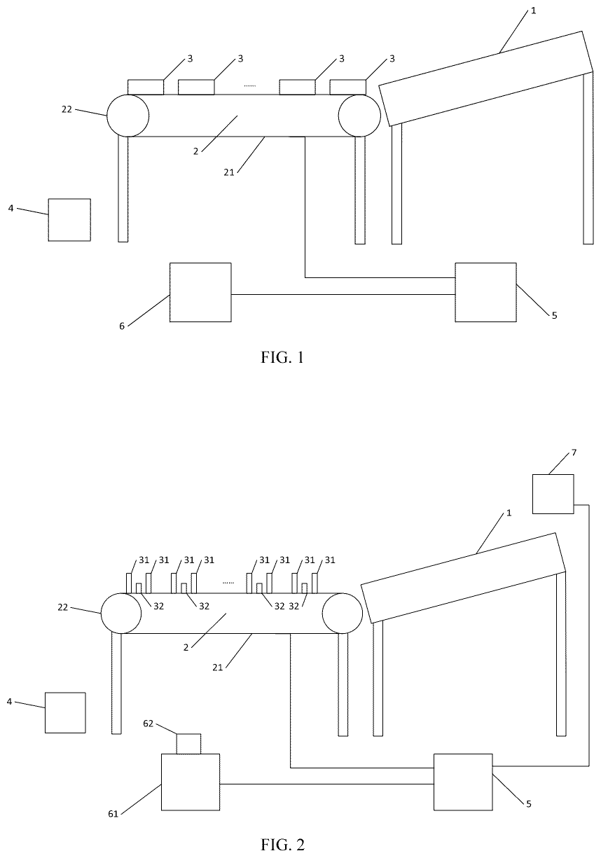

Therefore, in order to improve the detection efficiency of detecting the glass tube processing parameters, an embodiment of the present application provides a glass tube processing parameter detection system. As shown in FIG. 1, the system includes: a tube descending platform 1, a conveying apparatus 2, a plurality of clamping apparatuses 3, a tube descending basket 4, a terminal device 5, and a photographing apparatus 6;

An output terminal of the tube descending platform 1 is connected to an input terminal of the conveying apparatus 2, the tube descending basket 4 is disposed below an output terminal of the conveying apparatus 2, and an input terminal of the tube descending platform 1 is configured to deliver the glass tube to be detected;

The conveying apparatus 2 is electrically connected to the terminal device 5, the conveying apparatus 2 includes a conveyor belt 21 and conveyor belt rotating shafts 22, and a plurality of the clamping apparatuses 3 are disposed on the conveyor belt 21, and the clamping apparatuses 3 are configured to fix the glass tube to be detected;

The photographing apparatus 6 is disposed on one side of the conveying apparatus 2, the photographing apparatus 6 is electrically connected to the terminal device 5, the photographing apparatus 6 is configured to photograph end face images corresponding to the glass tube to be detected, and send the end face images corresponding to the glass tube to be detected to the terminal device 5;

The terminal device 5 is configured to control start and stop of rotation of the conveyor belt rotating shafts, and determine the processing parameters corresponding to the glass tube to be detected according to the end face images corresponding to the glass tube to be detected.

In which, the glass tube to be detected is a glass tube used for manufacturing optical fibers, the circle enclosed by the outer edge of the end face of the glass tube to be detected is the outer circle corresponding to the glass tube to be detected, and the circle enclosed by the inner edge of the end face of the glass tube to be detected is the inner circle corresponding to the glass tube to be detected. The inner-circle drawing diameter and the outer-circle drawing diameter corresponding to the glass tube to be detected can be, but are not limited to, 25 mm/27 mm, 29 mm/36 mm, 34 mm/35 mm, 40 mm/42 mm, etc., which are not specifically limited in the embodiments of the present application; in which, the tube descending platform 1 can specifically be a glass platform made of glass material, the tube descending platform 1 is placed obliquely, the width of the tube descending platform 1 is the same as the width of the conveyor belt 21, and the width of the tube descending platform 1 and the width of the conveyor belt 21 are both greater than the length of the glass tube to be detected; in which, the spacing between the output terminal of the tube descending platform 1 and the input terminal of the conveying apparatus 2 is determined according to the outer-circle drawing diameter corresponding to the glass tube to be detected and the height of the clamping apparatus 3. For example, if the height of the clamping apparatus 3 is 6 mm and the outer-circle drawing diameter corresponding to the glass tube to be detected is 36 mm, the spacing between the output terminal of the tube descending platform 1 and the input terminal of the conveying apparatus 2 can be set to 12 mm, so as to ensure that the glass tube to be detected will not fall to the ground from the gap between the output terminal of the tube descending platform 1 and the input terminal of the conveying apparatus 2, and that the clamping apparatus 3 can pass through the gap between the output terminal of the tube descending platform 1 and the input terminal of the conveying apparatus 2.

In which, the spacing between two adjacent clamping apparatuses 3 can be determined according to the outer-circle drawing diameter corresponding to the glass tube to be detected, that is, it is ensured that the spacing between two adjacent clamping apparatuses 3 is not much different from the outer-circle drawing diameter corresponding to the glass tube to be detected. For example, if the outer-circle drawing diameter corresponding to the glass tube to be detected is 36 mm, the spacing between two adjacent clamping apparatuses 3 can be set to 35 mm.

In which, the conveyor belt rotating shafts 22 are used for driving the conveyor belt 21 to rotate, the input terminal of the tube descending platform 1 is used for delivering the glass tube to be detected, the glass tube to be detected rolls from the input terminal of the tube descending platform to the clamping apparatus 3, the conveyor belt 21 drives the clamping apparatus 3 and the glass tube to be detected to move from the input terminal of the conveying apparatus 2 to the output terminal of the conveying apparatus 2, and the tube descending basket 4 is used for receiving the glass tube to be detected falling from the output terminal of the conveying apparatus 2.

In which, the tube descending basket 4 is covered with cotton or other buffer materials to prevent the glass tube to be detected from colliding and breaking when falling into the tube descending basket 4.

In the following, the glass tube processing parameter detection system in the embodiment of the present application is specifically explained through the working process and principle of the glass tube processing parameter detection system in the embodiment of the present application:

In which, the positions of the clamping apparatuses 3 on the conveyor belt 21 are adjusted by controlling the rotation of the conveyor belt rotating shafts 22 in advance, so as to ensure that there is a clamping apparatus 3 at the input terminal of the conveying apparatus 2 (that is, the input terminal of the conveyor belt 21).

Firstly, the glass tubes to be detected are delivered to the input terminal of the tube descending platform 1 according to a preset delivery interval duration, that is, after the first glass tube to be detected is delivered and after the preset delivery interval duration, the second glass tube to be detected is delivered, after the second glass tube to be detected is delivered and after the preset delivery interval duration, the third glass tube to be detected is delivered . . . ; and after the first glass tube to be detected is delivered and after a target rolling duration, the terminal device 5 controls the conveyor belt rotating shafts 22 to start rotating to drive the conveyor belt 21 to convey, in which, the target rolling duration is the time required for the glass tube to be detected to roll from the input terminal of the tube descending platform 1 to the output terminal of the tube descending platform 1, so that after the first glass tube to be detected is delivered and after the target rolling duration, the glass tube to be detected can just roll onto the clamping apparatus 3 at the input terminal of the conveying apparatus 2; in which, since the conveying speed of the conveyor belt 21 is determined according to the preset delivery interval duration, the target rolling duration, the spacing between two adjacent clamping apparatuses 3 and the size of the clamping apparatuses 3, it can be ensured that after the conveyor belt 21 conveys, each of the glass tubes to be detected delivered via the input terminal of the tube descending platform 1 can roll into the corresponding clamping apparatus 3.

Second, after the conveyor belt 21 conveys, the conveyor belt 21 can drive the clamping apparatus 3 and the glass tube to be detected to move from the input terminal of the conveying apparatus 2 to the output terminal of the conveying apparatus 2. When the clamping apparatus 3 and the glass tube to be detected move to the output terminal of the conveying apparatus 2, the glass tube to be detected will fall into the tube descending basket 4. At this time, the staff needs to pick up the glass tube to be detected in the tube descending basket 4 in time, so as to avoid the situation that the subsequent glass tubes to be detected falling into the tube descending basket 4 collide and break with the glass tube to be detected; in which, during the movement of the clamping apparatus 3 and the glass tube to be detected, when the clamping apparatus 3 and the glass tube to be detected move into the photographing range of the photographing apparatus 6, the photographing apparatus 6 can photograph the end face of the glass tube to be detected to obtain an end face image corresponding to the glass tube to be detected, and send the end face image corresponding to the glass tube to be detected to the terminal device 5.

Finally, the terminal device 5 determines the processing parameters corresponding to the glass tube to be detected according to the end face image corresponding to the glass tube to be detected, for example, the inner-circle processing diameter, the outer-circle processing diameter and the concentricity deviation value corresponding to the glass tube to be detected.

The glass tube processing parameter detection system can detect a large number of the processing parameters of the glass tubes to be detected according to the above working process without the intervention of the detection staff. Therefore, this can effectively reduce the time costs and labor costs consumed in detecting the processing parameters of the glass tube to be detected, thereby effectively improving detection efficiency.

The embodiment of the present application provides a glass tube processing parameter detection system. The system provided by the embodiment of the present application includes: a tube descending platform, a conveying apparatus, a plurality of clamping apparatuses, a tube descending basket, a terminal device, and a photographing apparatus; an output terminal of the tube descending platform is connected to an input terminal of the conveying apparatus, the tube descending basket is disposed below an output terminal of the conveying apparatus, and an input terminal of the tube descending platform is configured to deliver the glass tube to be detected; the conveying apparatus is electrically connected to the terminal device, the conveying apparatus includes a conveyor belt and conveyor belt rotating shafts, and a plurality of the clamping apparatuses are disposed on the conveyor belt, and the clamping apparatuses are configured to fix the glass tube to be detected, the conveyor belt rotating shafts are configured to drive the conveyor belt to convey, after delivering a glass tube to be detected to the input terminal of the tube descending platform, the glass tube to be detected rolls from the input terminal of the tube descending platform to the clamping apparatus, the conveyor belt drives the clamping apparatus and the glass tube to be detected to move from the input terminal of the conveying apparatus to the output terminal of the conveying apparatus, and the tube descending basket is used for receiving the glass tube to be detected falling from the output terminal of the conveying apparatus; the photographing apparatus is disposed on one side of the conveying apparatus, the photographing apparatus is electrically connected to the terminal device, the photographing apparatus is configured to photograph end face images corresponding to the glass tube to be detected, and send the end face images corresponding to the glass tube to be detected to the terminal device; the terminal device is configured to control start and stop of rotation of the conveyor belt rotating shafts, and determine the processing parameters corresponding to the glass tube to be detected according to the end face images corresponding to the glass tube to be detected. Since, in the embodiment of the present application, the detection staff only need to deliver the glass tube to be detected at the input terminal of the tube descending platform and pick up the detected glass tube in the tube descending basket, and other steps do not need to be participated by the detection staff, the glass tube processing parameter detection system can automatically complete the work of detecting the processing parameters of the glass tube to be detected. Therefore, this can effectively reduce the time costs and labor costs consumed in detecting the processing parameters of the glass tube to be detected, thereby effectively improving detection efficiency.

Further, as shown in FIG. 2, the clamping apparatus 3 includes: two brackets 31 and a light source device 32, in which, the two brackets 31 are disposed in parallel on the conveyor belt 21; the light source device 32 is disposed between the two brackets 31 and close to one side of the photographing apparatus 6. In the embodiment of the present application, the two brackets 31 are the same in size, and the size of each of the brackets 31 and the spacing between the two brackets 31 are determined according to the size of the glass tube to be detected, so as to ensure that the two brackets 31 can fix the glass tube to be detected after the glass tube to be detected rolls into the clamping apparatus 3; since when the photographing apparatus 6 is used to photograph the end face image of the glass tube to be detected, the information in the depth direction of the glass tube to be detected, such as the light in the depth direction, will be shielded, resulting in a dark end face image, the light source device 32 needs to be disposed between the two brackets 31 and close to one side of the photographing apparatus 6, so as to ensure that the brightness of the photographed end face image is normal.

Further, as shown in FIG. 2, the photographing apparatus 6 includes: an industrial camera 61 and a telecentric lens 62; in which, the telecentric lens 62 is mounted on the industrial camera 61. In the embodiment of the present application, in order to ensure that the clarity of the photographed end face image meets the detection requirements, the industrial camera 61 combined with the telecentric lens 62 is selected as the photographing apparatus 6; in which, in the actual use process, the chip target surface size, resolution and other parameters of the industrial camera 61 are determined according to the spacing between two adjacent clamping apparatuses 3 and the outer-circle drawing diameter corresponding to the glass tube to be detected. For example, if the outer-circle drawing diameter corresponding to the glass tube to be detected is 36 mm and the spacing between two adjacent clamping apparatuses 3 is 35 mm, the photographing range of the industrial camera 61 matched with the telecentric lens should be greater than twice the outer-circle drawing diameter corresponding to the glass tube to be detected. At the same time, in order to effectively use the space of the conveyor belt 21, the display range of the photographed image should be between 70 mm and 105 mm. Combined with the parameters of the telecentric lens, it can be calculated that the resolution of the selected industrial camera 61 should be ≥3 million pixels and ≤10 million pixels, and the chip target surface size should be ≥⅓ inch and ≤⅔ inch. When the selected resolution is low, the actual distance represented by a single pixel is wide, which will lead to low measurement accuracy; when the selected resolution is too high, the edge of the glass tube to be detected in the photographed end face image and the background are gradual, and it is difficult to determine the boundary line of the inner and outer edges of the glass tube to be detected.

Further, as shown in FIG. 2, the glass tube processing parameter detection system further includes: a delivery apparatus 7; the delivery apparatus 7 is disposed above the input terminal of the tube descending platform 1, the delivery apparatus 7 is electrically connected to the terminal device 5; the delivery apparatus 7 is configured to deliver the glass tube to be detected to the input terminal of the tube descending platform 1. In the embodiment of the present application, in order to ensure that the glass tubes to be detected can be delivered to the input terminal of the tube descending platform 1 accurately according to the preset delivery interval duration, the terminal device 5 can control the delivery apparatus 7 to deliver the glass tubes to be detected to the input terminal of the tube descending platform 1. The terminal device 5 pre-sets a timer for the delivery apparatus 7. After controlling the delivery apparatus 7 to deliver a glass tube to be detected to the input terminal of the tube descending platform 1, the terminal device 5 controls the timer corresponding to the delivery apparatus 7 to start timing. When the timer counts up to the preset delivery interval duration, the terminal device 5 controls the timer to clear, and controls the delivery apparatus 7 to deliver the next glass tube to be detected to the input terminal of the tube descending platform 1.

Further, the glass tube processing parameter detection system further includes: an alarm apparatus; the alarm apparatus is electrically connected to the terminal device 5, and the alarm apparatus is used for alarming. In the embodiment of the present application, after the terminal device 5 controls the photographing apparatus 6 to photograph the end face image corresponding to the glass tube to be detected, it is judged whether the glass tube to be detected is located within the central range of the end face image. If the glass tube to be detected is located within the central range of the end face image, the terminal device 5 determines the processing parameters corresponding to the glass tube to be detected according to the end face image corresponding to the glass tube to be detected; if the glass tube to be detected is located outside the central range of the end face image, the terminal device 5 controls the alarm apparatus to alarm, so as to prompt the staff that the glass tube to be detected is located outside the central range of the end face image and needs to re-photograph the end face image corresponding to the glass tube to be detected, and adjusts the position of the glass tube to be detected by controlling the rotation of the conveyor belt rotating shafts 22 until the glass tube to be detected is within the central range of the re-photographed end face image, and determines the processing parameters corresponding to the glass tube to be detected according to the re-photographed end face image.

Further, any one side or both sides of the tube descending platform 1 are provided with platform baffles. In the embodiment of the present application, in order to prevent the glass tube to be detected from deviating and rolling to the ground to collide and break during the rolling process on the tube descending platform 1, platform baffles need to be disposed on any one side or both sides of the tube descending platform 1 to prevent the glass tube to be detected from rolling to the ground.

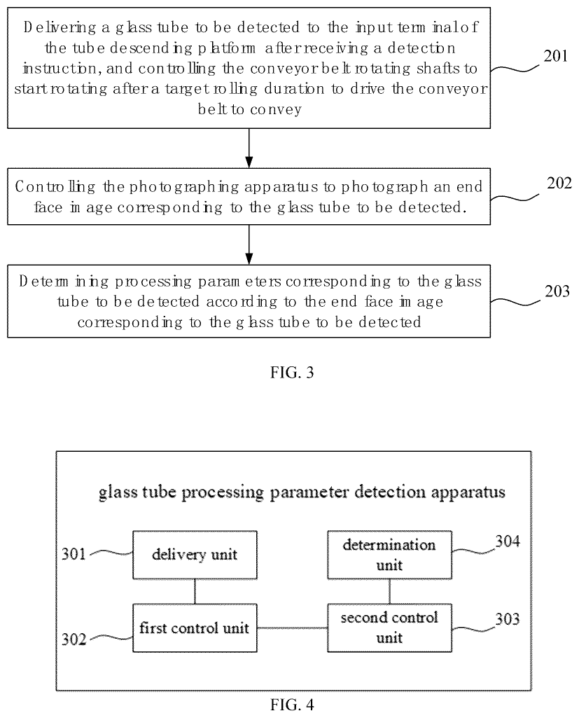

The embodiment of the present application further provides a glass tube processing parameter detection method, the method is applied to the glass tube processing parameter detection system shown in FIG. 1 or FIG. 2. The glass tube processing parameter detection system includes: a tube descending platform, a conveying apparatus, a plurality of clamping apparatuses, a tube descending basket, a terminal device, a photographing apparatus and a delivery apparatus. The execution subject of the method is the terminal device in the glass tube processing parameter detection system. The terminal device can be, but is not limited to, a computer, a laptop computer, a tablet computer, etc. Specifically, as shown in FIG. 3, the method includes:

201: Delivering a glass tube to be detected to the input terminal of the tube descending platform after receiving a detection instruction, and controlling the conveyor belt rotating shafts to start rotating after a target rolling duration to drive the conveyor belt to convey.

When the detection staff needs to detect the processing parameters of a batch of glass tubes to be detected with the same size, the detection staff needs to first select a plurality of corresponding clamping apparatuses according to the size of the glass tubes to be detected, and dispose a plurality of the clamping apparatuses on the conveyor belt. After the preparation work is completed, the staff sends a detection instruction to the terminal device through the input device of the terminal device. After receiving the detection instruction, the terminal device controls the delivery apparatus to deliver the glass tubes to be detected to the input terminal of the tube descending platform according to a preset delivery interval duration, that is, first controls the delivery apparatus to deliver the first glass tube to be detected, and after the delivery apparatus delivers the first glass tube to be detected and after the preset delivery interval duration, controls the delivery apparatus to deliver the second glass tube to be detected, and after the delivery apparatus delivers the second glass tube to be detected and after the preset delivery interval duration, controls the delivery apparatus to deliver the third glass tube to be detected . . . ; and after the first glass tube to be detected is delivered and after a target rolling duration, the terminal device controls the conveyor belt rotating shafts to start rotating to drive the conveyor belt to convey.

In which, the preset delivery interval duration can be, but is not limited to, 3 s, 4 s, 5 s, etc.; in which, the target rolling duration is the time required for the glass tube to be detected to roll from the input terminal of the tube descending platform to the output terminal of the tube descending platform, so that after the first glass tube to be detected is delivered and after the target rolling duration, the glass tube to be detected can just roll onto the clamping apparatus at the input terminal of the conveying apparatus; in which, since the conveying speed of the conveyor belt is determined according to the preset delivery interval duration, the target rolling duration, the spacing between two adjacent clamping apparatuses and the size of the clamping apparatuses, it can be ensured that after the conveyor belt conveys, each of the glass tubes to be detected delivered via the input terminal of the tube descending platform can roll into the corresponding clamping apparatus.

Further, in the embodiment of the present application, the terminal device needs to pre-calculate the target rolling duration corresponding to the glass tube to be detected and the conveying speed corresponding to the conveyor belt, and the specific process is:

Firstly, substituting an inner-circle drawing diameter and an outer-circle drawing diameter corresponding to the glass tube to be detected, a vertical distance between the input terminal and the output terminal of the tube descending platform, a friction coefficient corresponding to the tube descending platform, and a placement inclination angle into a preset formula to calculate the target rolling duration, in which, the preset formula is specifically as follows:

$$t = \frac{ω}{α} ω = \sqrt{\frac{2 gh}{\frac{1}{2} {r}_{1}^{2} + \frac{3}{2} {r}_{2}^{2}}} α = \frac{mg μ {r}_{2} cos θ}{\frac{1}{2} m ( {r}_{1}^{2} + {r}_{2}^{2} )}$$

In which, t is the target rolling duration, ω is the angular velocity corresponding to the glass tube to be detected, g is the acceleration of gravity, h is the vertical distance between the input terminal and the output terminal of the tube descending platform, r₁ is the inner-circle drawing diameter corresponding to the glass tube to be detected, r₂ is the outer-circle drawing diameter corresponding to the glass tube to be detected, α is the angular acceleration corresponding to the glass tube to be detected, m is the mass corresponding to the glass tube to be detected, is the friction coefficient corresponding to the tube descending platform, and θ is the placement inclination angle corresponding to the tube descending platform (that is, the angle between the tube descending platform and the horizontal plane).

Second, calculating a conveying speed corresponding to the conveyor belt according to the target rolling duration, a preset delivery interval duration, a spacing between two adjacent clamping apparatuses, and a bracket spacing corresponding to the clamping apparatuses, that is, the specific process is: first calculating the sum of the target rolling duration and the preset delivery interval duration to obtain a first calculation result, then calculating the sum of the spacing between two adjacent clamping apparatuses and the bracket spacing corresponding to the clamping apparatuses to obtain a second calculation result, and finally dividing the second calculation result by the first calculation result to obtain a third calculation result, where the third calculation result is the conveying speed corresponding to the conveyor belt; in which, the bracket spacing corresponding to the clamping apparatus is the distance between the two brackets included in the clamping apparatus.

In which, the specific process of the terminal device controls the conveyor belt rotating shafts to start rotating to drive the conveyor belt to convey is: controlling the conveyor belt rotating shafts to start rotating according to the conveying speed to drive the conveyor belt to convey at the conveying speed.

202: Controlling the photographing apparatus to photograph an end face image corresponding to the glass tube to be detected.

After the conveyor belt conveys, the conveyor belt can drive the clamping apparatus and the glass tube to be detected to move from the input terminal of the conveying apparatus to the output terminal of the conveying apparatus. During the movement of the clamping apparatus and the glass tube to be detected, when the clamping apparatus and the glass tube to be detected move into the photographing range of the photographing apparatus, the terminal device can control the photographing apparatus to photograph the end face of the glass tube to be detected to obtain an end face image corresponding to the glass tube to be detected.

In which, the terminal device can pre-determine the photographing interval duration corresponding to the photographing apparatus, so that in this step, the terminal device can control the photographing apparatus to photograph the end face image corresponding to the glass tube to be detected according to the photographing interval duration corresponding to the photographing apparatus;

Specifically, the specific process of the terminal device determining the photographing interval duration corresponding to the photographing apparatus is: dividing the horizontal distance between the photographing apparatus and the input terminal of the conveying apparatus by the conveying speed corresponding to the conveyor belt to obtain a first photographing interval duration; determining the first calculation result calculated in step 201 as a second photographing interval duration; specifically, the specific process of the terminal device controlling the photographing apparatus to photograph the end face image corresponding to the glass tube to be detected according to the photographing interval duration corresponding to the photographing apparatus is: the terminal device pre-sets a timer for the delivery apparatus; after the terminal device controls the conveyor belt rotating shafts to start rotating, the terminal device controls the timer corresponding to the photographing apparatus to start timing; when the timer counts up to the first photographing interval duration, the terminal device controls the timer to clear, controls the photographing apparatus to photograph the end face image corresponding to the first glass tube to be detected, and controls the timer to start timing again; when the timer counts up to the second photographing interval duration, the terminal device controls the timer to clear, controls the photographing apparatus to photograph the end face image corresponding to the second glass tube to be detected, and controls the timer to start timing again; when the timer counts up to the second photographing interval duration, the terminal device controls the timer to clear, controls the photographing apparatus to photograph the end face image corresponding to the third glass tube to be detected, and controls the timer to start timing again . . . .

203: Determining processing parameters corresponding to the glass tube to be detected according to the end face image corresponding to the glass tube to be detected.

After the terminal device acquires the end face image corresponding to the glass tube to be detected, the terminal device can determine the processing parameters corresponding to the glass tube to be detected according to the end face image corresponding to the glass tube to be detected, and the specific process is: firstly, generating an edge binary image corresponding to the glass tube to be detected according to preset rules, a plurality of preset mask matrices, and the end face image, in which, the edge binary image includes a first circular ring composed of a plurality of first pixel points and a second circular ring composed of a plurality of second pixel points, the gray values of a plurality of the first pixel points and a plurality of the second pixel points are 1, and the gray values of other pixel points in the edge binary image are 0; Second, determining a center coordinate corresponding to the first circular ring according to coordinates corresponding to each of the first pixel points, and determining a center coordinate corresponding to the second circular ring according to coordinates corresponding to each of the second pixel points, in which, the center coordinate corresponding to the first circular ring is the coordinate corresponding to the center point of the first circular ring in the edge binary image, and the center coordinate corresponding to the second circular ring is the coordinate corresponding to the center point of the second circular ring in the edge binary image; Finally, determining an inner-circle processing diameter, an outer-circle processing diameter and a concentricity deviation value corresponding to the glass tube to be detected according to coordinates corresponding to each of the first pixel points, coordinates corresponding to each of the second pixel points, a center coordinate corresponding to the first circular ring and a center coordinate corresponding to the second circular ring; Specifically, in this step, the specific process of the terminal device generates an edge binary image corresponding to the glass tube to be detected according to preset rules, a plurality of preset mask matrices, and the end face image is:

(1) Performing convolution operations processing on the end face image by using a plurality of preset mask matrices to obtain an edge image corresponding to the glass tube to be detected.

In which, a plurality of the preset mask matrices include a noise reduction mask matrix, a slope mask matrix, and an edge mask matrix;

After the terminal device acquires an end face image corresponding to a glass tube to be detected, the terminal device can first perform convolution operations processing on the end face image by using a plurality of preset mask matrices to obtain an edge image corresponding to the glass tube to be detected. The specific process is: firstly, performing convolution operations processing on the end face image by using the noise reduction mask matrix to obtain a noise reduced image corresponding to the glass tube to be detected; second, performing convolution operations processing on the noise reduced image by using the slope mask matrix to obtain a gradient image corresponding to the glass tube to be detected; finally, performing convolution operations processing on the gradient image by using the edge mask matrix to obtain the edge image corresponding to the glass tube to be detected.

It should be noted that performing convolution operations processing on the end face image by using the noise reduction mask matrix can improve image quality of the end face image and suppress noise points in the end face image; performing convolution operations processing on the noise reduced image by using the slope mask matrix can ensure that it is sensitive to the gray value of the edge position of the glass tube in the noise reduced image without changing the overall gray of the noise reduced image, so that the gray value of the edge position of the glass tube can be retained as much as possible and the gray value of the background color can be effectively suppressed; performing convolution operations processing on the gradient image by using the edge mask matrix can enhance the gray value of the edge center point of the glass tube edge in the gradient image.

It should be noted that the type of convolution operations performed above is specifically the “same” convolution operations, that is, performing the “same” convolution operations processing on the end face image by using the noise reduction mask matrix; performing the “same” convolution operations processing on the noise reduced image by using the slope mask matrix; performing the “same” convolution operations processing on the gradient image by using the edge mask matrix.

In which, the noise reduction mask matrix is specifically:

| | | | | |
|---|---|---|---|---|
| 1/32 | 1/32 | 1/16 | 1/32 | 1/32 |
| 1/32 | 1/16 | ⅛ | 1/16 | 1/32 |
| 1/16 | ⅛ | ⅛ | ⅛ | 1/16 |
| 1/32 | 1/16 | ⅛ | 1/16 | 1/32 |
| 1/32 | 1/32 | 1/16 | 1/32 | 1/32 |

The slope mask matrix is specifically:

| | | | | |
|---|---|---|---|---|
| 1/16 | 1/16 | 1/16 | 1/16 | 1/16 |
| 1/16 | −⅛ | −⅛ | −⅛ | 1/16 |
| 1/16 | −⅛ | 1 | −⅛ | 1/16 |
| 1/16 | −⅛ | −⅛ | −⅛ | 1/16 |
| 1/16 | 1/16 | 1/16 | 1/16 | 1/16 |

The edge mask matrix is specifically:

| | | | | |
|---|---|---|---|---|
| 1/64 | 1/64 | 1/64 | 1/64 | 1/64 |
| 1/64 | 1/32 | 1/32 | 1/32 | 1/64 |
| 1/64 | 1/32 | ½ | 1/32 | 1/64 |
| 1/64 | 1/32 | 1/32 | 1/32 | 1/64 |
| 1/64 | 1/64 | 1/64 | 1/64 | 1/64 |

(2) Generating the edge binary image corresponding to the glass tube to be detected according to a gray value corresponding to each of the pixel points in the edge image.

After the terminal device acquires the edge image corresponding to the glass tube to be detected, the terminal device can generate the edge binary image corresponding to the glass tube to be detected according to a gray value corresponding to each of the pixel points in the edge image. The specific process is: firstly, dividing a maximum gray value among gray values corresponding to each of the pixel points in the edge image by 2 to obtain a target gray value; then, determining pixel points in the edge image with gray values greater than the target gray value as third pixel points, and determining pixel points in the edge image with gray values less than or equal to the target gray value as fourth pixel points; then, generating a target image, in which, a plurality of pixel points in the target image correspond one-to-one with a plurality of pixel points in the edge image; finally, setting gray values of pixel points in the target image corresponding to each of the third pixel points to 1, and setting gray values of pixel points in the target image corresponding to each of the fourth pixel points to 0, to obtain the edge binary image. For example, determining the pixel point in the third row and the fifth column in the edge image as third pixel point, and setting the gray value of the pixel point in the third row and the fifth column in the target image to 1; determining the pixel point in the fifth row and the fifth column in the edge image as fourth pixel point, and setting the gray value of the pixel point in the fifth row and the fifth column in the target image to 0 . . . .

Specifically, in this step, the specific process for the terminal device determines a center coordinate corresponding to the first circular ring according to coordinates corresponding to each of the first pixel points, and determines a center coordinate corresponding to the second circular ring according to coordinates corresponding to each of the second pixel points is:

(1) For any one of pixel points in the edge binary image, calculating distances from the pixel points to each of the first pixel points according to coordinates corresponding to the pixel points and coordinates corresponding to each of the first pixel points, and determining a maximum value among a plurality of the calculated distances as a first maximum distance corresponding to the pixel point, so that it is able to determine a first maximum distance corresponding to each of the pixel point in the edge binary image; determining a pixel point corresponding to a minimum value among a plurality of the determined first maximum distances as a center point corresponding to the first circular ring, and determining a coordinate corresponding to the center point as the center coordinate corresponding to the first circular ring.

(2) For any one of pixel points in the edge binary image, calculating distances from the pixel points to each of the second pixel points according to coordinates corresponding to the pixel points and coordinates corresponding to each of the second pixel points, and determining a maximum value among a plurality of the calculated distances as a second maximum distance corresponding to the pixel point, so that it is able to determine a second maximum distance corresponding to each of the pixel point in the edge binary image; determining a pixel point corresponding to a minimum value among a plurality of the determined second maximum distances as a center point corresponding to the second circular ring, and determining a coordinate corresponding to the center point as the center coordinate corresponding to the second circular ring.

It should be noted that for a plane containing a circle, when a point in the plane is outside the circle, the maximum distance from the point to the circle is the nearest distance from the point to the circle plus the diameter of the circle; when a point in the plane is on the circle, the maximum distance from the point to the circle is the diameter of the circle; when a point in the plane is inside the circle but not at the center, the maximum distance from the point to the circle is the distance from the point to the center plus the radius of the circle; when a point in the plane is at the center, the maximum distance from the point to the circle is the radius of the circle. Therefore, after determining the maximum distances from each of the points to the circle in the plane, a point corresponding to a minimum value among a plurality of the maximum distances is the center of the circle.

Specifically, in this step, the specific process for the terminal device determines a concentricity deviation value corresponding to the glass tube to be detected according to the center coordinate corresponding to the first circular ring and the center coordinate corresponding to the second circular ring is:

Firstly, calculating an image concentricity deviation value corresponding to the glass tube to be detected according to the center coordinate corresponding to the first circular ring and the center coordinate corresponding to the second circular ring, that is, calculating the distance between the center point of the first circular ring and the center point of the second circular ring in the edge binary image according to a coordinate of the center point of the first circular ring in the edge binary image (that is, a center coordinate corresponding to the first circular ring) and a coordinate of the center point of the second circular ring in the edge binary image (that is, a center coordinate corresponding to the second circular ring), and determining the distance as the concentricity deviation value between the first circular ring and the second circular ring (that is, the concentricity deviation value of the image corresponding to the glass tube to be detected); then, determine the concentricity deviation value corresponding to the glass tube to be detected according to a pixel size corresponding to the edge binary image and the concentricity deviation value of the image, that is, multiplying the concentricity deviation value of the image by the pixel size corresponding to the edge binary image to obtain the concentricity deviation value corresponding to the glass tube to be detected.

Further, in the embodiment of the present application, after the terminal device controls the photographing apparatus to photograph the end face image corresponding to the glass tube to be detected, it is further necessary to judge whether the glass tube to be detected is located within the central range of the end face image; if the glass tube to be detected is located within the central range of the end face image, the terminal device can directly determine the processing parameters corresponding to the glass tube to be detected according to the end face image corresponding to the glass tube to be detected by using the method described in the above step 203; if the glass tube to be detected is located outside the central range of the end face image, the terminal device needs to adjust a position of the glass tube to be detected by controlling the rotation of the conveyor belt rotating shafts until the glass tube to be detected is within a central range of a re-photographed end face image. At this time, the processing parameters corresponding to the glass tube to be detected need to be determined according to the re-photographed end face image, and the specific process can refer to the method described in the above step 203. The central area of the end face image is the area between ¼ and ¾ of the horizontal direction of the end face image. When both the center of the first circular ring and the center of the second circular ring corresponding to the glass tube to be detected are within the central area of the end face image, it can be determined that the glass tube to be detected is located within the central range of the end face image. When the center of the first circular ring and/or the center of the second circular ring corresponding to the glass tube to be detected are outside the central area of the end face image, it can be determined that the glass tube to be detected is located outside the central range of the end face image, but is not limited thereto.

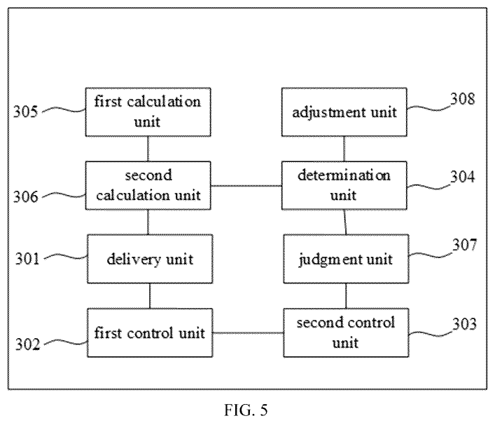

Further, as an implementation of the method shown in FIG. 3, another embodiment of the present application further provides a glass tube processing parameter detection apparatus. This apparatus embodiment corresponds to the previous method embodiment. For ease of reading, this apparatus embodiment will not repeat the detailed contents of the previous method embodiment one by one, but it should be clear that the apparatus in this embodiment can correspondingly implement all the contents of the previous method embodiment. The apparatus is applied to improving the detection efficiency of detecting the glass tube processing parameters. Specifically, as shown in FIG. 4, the apparatus includes:
A delivery unit 301, configured to deliver a glass tube to be detected to the input terminal of the tube descending platform after receiving a detection instruction;
A first control unit 302, configured to control the conveyor belt rotating shafts to start rotating after a target rolling duration to drive the conveyor belt to convey;
A second control unit 303, configured to control the photographing apparatus to photograph an end face image corresponding to the glass tube to be detected;
A determination unit 304, configured to determine processing parameters corresponding to the glass tube to be detected according to the end face image corresponding to the glass tube to be detected.

Further, as shown in FIG. 5, the apparatus further includes:
A first calculation unit 305, configured to substitute an inner-circle drawing diameter and an outer-circle drawing diameter corresponding to the glass tube to be detected, α vertical distance between the input terminal and the output terminal of the tube descending platform, a friction coefficient corresponding to the tube descending platform, and a placement inclination angle into a preset formula to calculate the target rolling duration;
A second calculation unit 306, configured to calculate a conveying speed corresponding to the conveyor belt according to the target rolling duration, a preset delivery interval duration, a spacing between two adjacent clamping apparatuses, and a bracket spacing corresponding to the clamping apparatuses;
The first control unit 302, specifically configured to control the conveyor belt rotating shafts to start rotating according to the conveying speed to drive the conveyor belt to convey at the conveying speed.

Further, as shown in FIG. 5, the determination unit 304, specifically configured to generate an edge binary image corresponding to the glass tube to be detected according to preset rules, a plurality of preset mask matrices, and the end face image, in which, the edge binary image includes a first circular ring composed of a plurality of first pixel points and a second circular ring composed of a plurality of second pixel points; determine a center coordinate corresponding to the first circular ring according to coordinates corresponding to each of the first pixel points, and determine a center coordinate corresponding to the second circular ring according to coordinates corresponding to each of the second pixel points; determine an inner-circle processing diameter, an outer-circle processing diameter and a concentricity deviation value corresponding to the glass tube to be detected according to coordinates corresponding to each of the first pixel points, coordinates corresponding to each of the second pixel points, a center coordinate corresponding to the first circular ring and a center coordinate corresponding to the second circular ring.

Further, as shown in FIG. 5, the apparatus further includes:
A judgment unit 307, configured to judge whether the glass tube to be detected is located within the central range of the end face image after the second control unit 303 controls the photographing apparatus to photograph the end face image corresponding to the glass tube to be detected;
The determination unit 304, specifically configured to determine the processing parameters corresponding to the glass tube to be detected according to the end face image corresponding to the glass tube to be detected when the judgment unit 307 determines that the glass tube to be detected is located within the central range of the end face image;
An adjustment unit 308, configured to adjust a position of the glass tube to be detected by controlling the rotation of the conveyor belt rotating shafts until the glass tube to be detected is within a central range of a re-photographed end face image when the judgment unit 307 determines that the glass tube to be detected is located outside the central range of the end face image, and determine the processing parameters corresponding to the glass tube to be detected according to the re-photographed end face image.

The embodiment of the present application provides a glass tube processing parameter detection system, method and apparatus. The glass tube processing parameter detection system provided by the embodiment of the present application includes: a tube descending platform, a conveying apparatus, a plurality of clamping apparatuses, a tube descending basket, a terminal device, and a photographing apparatus; an output terminal of the tube descending platform is connected to an input terminal of the conveying apparatus, the tube descending basket is disposed below an output terminal of the conveying apparatus, and an input terminal of the tube descending platform is configured to deliver the glass tube to be detected; the conveying apparatus is electrically connected to the terminal device, the conveying apparatus includes a conveyor belt and conveyor belt rotating shafts, and a plurality of the clamping apparatuses are disposed on the conveyor belt, the clamping apparatuses are configured to fix the glass tube to be detected, the conveyor belt rotating shafts are configured to drive the conveyor belt to convey, after delivering a glass tube to be detected to the input terminal of the tube descending platform, the glass tube to be detected rolls from the input terminal of the tube descending platform to the clamping apparatus, the conveyor belt drives the clamping apparatus and the glass tube to be detected to move from the input terminal of the conveying apparatus to the output terminal of the conveying apparatus, and the tube descending basket is used for receiving the glass tube to be detected falling from the output terminal of the conveying apparatus; the photographing apparatus is disposed on one side of the conveying apparatus, the photographing apparatus is electrically connected to the terminal device, the photographing apparatus is configured to photograph end face images corresponding to the glass tube to be detected, and send the end face images corresponding to the glass tube to be detected to the terminal device; the terminal device is configured to control start and stop of rotation of the conveyor belt rotating shafts, and determine the processing parameters corresponding to the glass tube to be detected according to the end face images corresponding to the glass tube to be detected. Since, in the embodiment of the present application, the detection staff only need to deliver the glass tube to be detected at the input terminal of the tube descending platform and pick up the detected glass tube in the tube descending basket, and other steps do not need to be participated by the detection staff, the glass tube processing parameter detection system can automatically complete the work of detecting the processing parameters of the glass tube to be detected. Therefore, this can effectively reduce the time costs and labor costs consumed in detecting the processing parameters of the glass tube to be detected, thereby effectively improving detection efficiency.

The embodiment of the present application provides a storage medium. The storage medium includes a stored program, in which, the program, when executed, controls a device in which the storage medium is located to perform the glass tube processing parameter detection method described above.

The storage medium may include the forms of non-permanent memory, random access memory (RAM), and/or non-volatile memory in computer-readable media, such as read-only memory (ROM) or flash memory (flash RAM). The memory is an example of computer-readable media.

The embodiment of the present application further provides a glass tube processing parameter detection apparatus. The apparatus includes a storage medium; and one or more processors, the storage medium is coupled to the processor, and the processor is configured to perform program instructions stored in the storage medium; the program instructions, when executed, perform the glass tube processing parameter detection method described above.

The embodiment of the present application provides a device. The device includes a processor, a memory, and a program stored in the memory and capable of executing on the processor. When the processor performs the program, the following steps are implemented:
Delivering a glass tube to be detected to the input terminal of the tube descending platform after receiving a detection instruction, and controlling the conveyor belt rotating shafts to start rotating after a target rolling duration to drive the conveyor belt to convey;
Controlling the photographing apparatus to photograph an end face image corresponding to the glass tube to be detected;
Determining processing parameters corresponding to the glass tube to be detected according to the end face image corresponding to the glass tube to be detected.

Further, the method further includes:
Substituting an inner-circle drawing diameter and an outer-circle drawing diameter corresponding to the glass tube to be detected, α vertical distance between the input terminal and the output terminal of the tube descending platform, a friction coefficient corresponding to the tube descending platform, and a placement inclination angle into a preset formula to calculate the target rolling duration;
Calculating a conveying speed corresponding to the conveyor belt according to the target rolling duration, a preset delivery interval duration, a spacing between two adjacent clamping apparatuses, and a bracket spacing corresponding to the clamping apparatuses;

The step of controlling the conveyor belt rotating shafts to start rotating to drive the conveyor belt to convey includes:
Controlling the conveyor belt rotating shafts to start rotating according to the conveying speed to drive the conveyor belt to convey at the conveying speed.

Further, the step of determining processing parameters corresponding to the glass tube to be detected according to the end face image corresponding to the glass tube to be detected includes:
Generating an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
Determining a center coordinate corresponding to the first circular ring according to coordinates corresponding to each of the first pixel points, and determining a center coordinate corresponding to the second circular ring according to coordinates corresponding to each of the second pixel points;
Determining an inner-circle processing diameter, an outer-circle processing diameter and a concentricity deviation value corresponding to the glass tube to be detected according to coordinates corresponding to each of the first pixel points, coordinates corresponding to each of the second pixel points, a center coordinate corresponding to the first circular ring and a center coordinate corresponding to the second circular ring.

Further, after the step of controlling the photographing apparatus to photograph an end face image corresponding to the glass tube to be detected, the method further includes:
Determining whether the glass tube to be detected is located within a central range of the end face image;
If yes, proceeding to the step of determining the processing parameters corresponding to the glass tube to be detected according to the end face image corresponding to the glass tube to be detected;
If no, adjusting a position of the glass tube to be detected by controlling the rotation of the conveyor belt rotating shafts until the glass tube to be detected is within a central range of a re-photographed end face image, and determining the processing parameters corresponding to the glass tube to be detected according to the re-photographed end face image.

The present application further provides a computer program product. When the computer program product performed on a data processing device, the computer program product is adapted to perform program code for initializing the following method steps: delivering a glass tube to be detected to the input terminal of the tube descending platform after receiving a detection instruction, and controlling the conveyor belt rotating shafts to start rotating after a target rolling duration to drive the conveyor belt to convey; controlling the photographing apparatus to photograph an end face image corresponding to the glass tube to be detected; determining processing parameters corresponding to the glass tube to be detected according to the end face image corresponding to the glass tube to be detected.

Those skilled in the art will understand that the embodiments of the present application can be provided as a method, system or computer program product. Accordingly, the present application can take the form of an entirely hardware embodiment, an entirely software embodiment or an embodiment combining software and hardware aspects. Furthermore, the present application can take the form of a computer program product implemented on one or more computer-usable storage media (including but not limited to disk storage, CD-ROM, optical storage, etc.) containing computer-usable program codes.

The present application is described with reference to flowcharts and/or block diagrams of methods, devices (systems), and computer program products according to the embodiments of the present application. It should be understood that each process and/or block in the flowcharts and/or block diagrams, and combinations of processes and/or blocks in the flowcharts and/or block diagrams, can be implemented by computer program instructions. These computer program instructions can be provided to a processor of a general-purpose computer, a special-purpose computer, an embedded processor, or other programmable data processing device to produce a machine, such that the instructions, which perform through the processor of the computer or other programmable data processing device, produce apparatuses for implementing the functions specified in one or more processes in the flowchart and/or one or more blocks in the block diagram.

These computer program instructions can also be stored in a computer-readable memory that can direct a computer or other programmable data processing device to function in a particular manner, such that the instructions stored in the computer-readable memory produce an article of manufacture including instruction apparatuses, the instruction apparatuses implement the functions specified in one or more processes in the flowchart and/or one or more blocks in the block diagram.

These computer program instructions can also be loaded onto a computer or other programmable data processing device to cause a series of operational steps to be performed on the computer or other programmable device to produce a computer-implemented process, such that the instructions which perform on the computer or other programmable device provide steps for implementing the functions specified in one or more processes in the flowchart and/or one or more blocks in the block diagram.

In a typical configuration, a computing device includes one or more processors (CPU), input/output interfaces, network interfaces, and memory.

The memory may include the forms of non-permanent memory, random access memory (RAM), and/or non-volatile memory in computer-readable media, such as read-only memory (ROM) or flash memory (flash RAM). The memory is an example of computer-readable media.

Computer-readable media include permanent and non-permanent, removable and non-removable media that can store information by any method or technology. Information can be computer-readable instructions, data structures, program modules, or other data. Examples of computer storage media include, but are not limited to, phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic tape magnetic disk storage or other magnetic storage devices, or any other non-transitory medium that can be used to store information accessible by a computing device. As defined herein, computer-readable media does not include transitory media, such as modulated data signals and carrier waves.

It should also be noted that the terms “including”, “comprising”, or any of their variations are intended to cover non-exclusive inclusion, thereby enabling a process, method, product or device that includes a series of elements to not only include those elements, but also to include other elements that are not explicitly listed, or to include elements inherent to such a process, method, product or device. Without further limitations, the elements limited by the statement “including one . . . ” do not exclude the existence of other identical elements in the process, method, product or device that includes those elements.

It should be understood by those skilled in the art that the embodiments of the present application may be implemented as methods, systems or computer program products. Therefore, the present application may take the form of a fully hardware implementation, a fully software implementation, or an implementation combining software and hardware aspects. Moreover, the present application can take the form of a computer program product implemented on one or more computer-usable storage media (including but not limited to disk storage, CD-ROM, optical storage, etc.) containing computer-usable program codes.

The above are merely embodiments of the present application and do not limit the scope of the present application. For those skilled in the art, the present application may have various modifications and variations. Any changes, equivalents, improvements, etc. made within the spirit and principles of the present application shall be included within the scope of the claims of the present application.

1. A glass tube processing parameter detection system, comprising: a tube descending platform, a conveying apparatus, a plurality of clamping apparatuses, a tube descending basket, a terminal device, and a photographing apparatus;
wherein an output terminal of the tube descending platform is connected to an input terminal of the conveying apparatus, the tube descending basket is disposed below an output terminal of the conveying apparatus, and an input terminal of the tube descending platform is configured to deliver the glass tube to be detected;
wherein the conveying apparatus is electrically connected to the terminal device, the conveying apparatus comprises a conveyor belt and conveyor belt rotating shafts, and a plurality of the clamping apparatuses are disposed on the conveyor belt, and the clamping apparatuses are configured to fix the glass tube to be detected;
wherein the photographing apparatus is disposed on one side of the conveying apparatus, the photographing apparatus is electrically connected to the terminal device, the photographing apparatus is configured to photograph end face images corresponding to the glass tube to be detected, and send the end face images corresponding to the glass tube to be detected to the terminal device; and
wherein the terminal device is configured to control start and stop of rotation of the conveyor belt rotating shafts, and determine the processing parameters corresponding to the glass tube to be detected according to the end face images corresponding to the glass tube to be detected.

2. The system according to claim 1, wherein the clamping apparatus comprises:
two brackets and a light source device, the two brackets are disposed in parallel on the conveyor belt;
the light source device is disposed between the two brackets and close to one side of the photographing apparatus.

3. The system according to claim 1, wherein the photographing apparatus comprises:
an industrial camera and a telecentric lens,
wherein the telecentric lens is mounted on the industrial camera.

4. The system according to claim 1, wherein the system further comprises: a delivery apparatus;
wherein the delivery apparatus is disposed above the input terminal of the tube descending platform, the delivery apparatus is electrically connected to the terminal device; and
wherein the delivery apparatus is configured to deliver the glass tube to be detected to the input terminal of the tube descending platform.

5. A glass tube processing parameter detection method, wherein the method is applied to the terminal device in the glass tube processing parameter detection system according to claim 1, the method comprising:
delivering a glass tube to be detected to the input terminal of the tube descending platform after receiving a detection instruction, and controlling the conveyor belt rotating shafts to start rotating after a target rolling duration to drive the conveyor belt to convey;
controlling the photographing apparatus to photograph an end face image corresponding to the glass tube to be detected;
determining processing parameters corresponding to the glass tube to be detected according to the end face image corresponding to the glass tube to be detected.

6. The method according to claim 5, the method further comprising:
substituting an inner-circle drawing diameter, an outer-circle drawing diameter, a vertical distance between the input terminal and the output terminal of the tube descending platform, a friction coefficient corresponding to the tube descending platform, and a placement inclination angle into a preset formula to calculate the target rolling duration;
calculating a conveying speed corresponding to the conveyor belt according to the target rolling duration, a preset delivery interval duration, a spacing between two adjacent clamping apparatuses, and a bracket spacing corresponding to the clamping apparatuses;
the step of controlling the conveyor belt rotating shafts to start rotating to drive the conveyor belt to convey comprises:
controlling the conveyor belt rotating shafts to start rotating according to the conveying speed to drive the conveyor belt to convey at the conveying speed.

7. The method according to claim 5, wherein the step of determining processing parameters corresponding to the glass tube to be detected according to the end face image corresponding to the glass tube to be detected comprises:
generating an edge binary image corresponding to the glass tube to be detected according to preset rules, a plurality of preset mask matrices, and the end face image, wherein the edge binary image includes a first circular ring composed of a plurality of first pixel points and a second circular ring composed of a plurality of second pixel points;
determining a center coordinate corresponding to the first circular ring according to coordinates corresponding to each of the first pixel points, and determining a center coordinate corresponding to the second circular ring according to coordinates corresponding to each of the second pixel points;
determining an inner-circle processing diameter, an outer-circle processing diameter and a concentricity deviation value corresponding to the glass tube to be detected according to coordinates corresponding to each of the first pixel points, coordinates corresponding to each of the second pixel points, a center coordinate corresponding to the first circular ring and a center coordinate corresponding to the second circular ring.

8. The method according to claim 5, wherein after the step of controlling the photographing apparatus to photograph an end face image corresponding to the glass tube to be detected, the method further comprises:
judging whether the glass tube to be detected is located within a central range of the end face image;
if yes, proceeding to the step of determining the processing parameters corresponding to the glass tube to be detected according to the end face image corresponding to the glass tube to be detected;
if no, adjusting a position of the glass tube to be detected by controlling the rotation of the conveyor belt rotating shafts until the glass tube to be detected is within a central range of a re-photographed end face image, and determining the processing parameters corresponding to the glass tube to be detected according to the re-photographed end face image.

9. A glass tube processing parameter detection apparatus, wherein the apparatus is applied to the terminal device in the glass tube processing parameter detection system according to claim 1, the apparatus comprising:
a delivery unit, configured to deliver a glass tube to be detected to the input terminal of the tube descending platform after receiving a detection instruction;
a first control unit, configured to control the conveyor belt rotating shafts to start rotating after a target rolling duration to drive the conveyor belt to convey;
a second control unit, configured to control the photographing apparatus to photograph an end face image corresponding to the glass tube to be detected;
a determination unit, configured to determine processing parameters corresponding to the glass tube to be detected according to the end face image corresponding to the glass tube to be detected.

10. A storage medium, comprising a stored program, wherein the program, when executed, controls a device in which the storage medium is located to perform the glass tube processing parameter detection method according to claim 5.
